(19) United States
(12) Patent Application Publication
(10) Pub. No.: US 2014/0054238 A1
(43) Pub. Date: Feb. 27, 2014

(54) Water Treatment

(71) Applicant: Morten Aga, Vaksdal (NO)

(72) Inventor: Morten Aga, Vaksdal (NO)

(73) Assignee: Seafarm Products AS, Vaksdal (NO)

(21) Appl. No.: 13/988,773

(22) PCT Filed: Nov. 24, 2011
(86) PCT No.: PCT/EP11/70993

§ 371 Date: Jul. 24, 2013

(30) Foreign Application Priority Data
Nov. 24, 2010 (GB) 1019993.3

(51) Int. Cl. C02F 9/00

(52) U.S. Cl. CPC C02F 9/00
USPC 210/748.02; 210/808; 210/748.1; 210/748.01; 210/774; 210/754; 210/760; 210/749; 210/188

(57) ABSTRACT

A method of treating water, applicable to sterilise water for drinking or to treat ballast water, may include flowing water through a conduit containing a reduced pressure zone arranged to reduce the pressure of the flow by at least 10² to a sub-atmospheric pressure. The method may include passing water through a siphon conduit having a headspace provided with a gas removal pump.

This invention relates to methods and apparatus for treating water, including a process for transferring ballast water and apparatus suitable therefor.

When cargo transport ships are unloaded or underloaded they are more unstable than when loaded as their centre of gravity is higher. For this reason ships are provided with ballast tanks which may be filled with water (so-called “ballast water”) to lower the centre of gravity of the unloaded ship to increase stability. Frequently this involves providing the ship with a double hull with the space between the inner and outer hulls providing the ballast tanks.

The use of water from the location where the ship is unloaded to provide the ballast water however can result in biological contamination when the ballast water is discharged in another location before the ship is reloaded. While the option exists to discharge ballast water on voyage between the unloading and reloading locations and to take on further relatively uncontaminated ballast water far offshore, this involves loading and discharging ballast water twice rather than once and may leave the ship temporarily less stable while at sea.

Another alternative is to treat the ballast water that is loaded to kill off at least multi-cellular biological contaminants, e.g. small fish and shellfish. This can be done for example by subjecting the ballast water to chemical treatment, to de-oxygenation or to treatment with varying electric fields. Chemical treatment raises the risk of chemical, as opposed to biological, contamination at the ballast water discharge location and the other forms of treatment may involve complicated and expensive equipment and/or high levels of energy usage.

We have now found that ballast water degassing (which besides destroying multi-cellular biological contaminants also reduces the ability of the ballast water to corrode the ballast tanks) may be particularly simply and effectively done with minimal energy demand by transferring ballast water from the surroundings (e.g. sea, lake or river water) using a siphon having a headspace provided with a gas removal pump, e.g. a vacuum pump, providing a gas pressure of no more than 0.5 atm in the headspace, preferably no more than 0.15 atm.

Thus viewed from one aspect the invention provides a process for loading a ballast tank of a ship in a water mass (e.g. the sea, or a river or lake) with ballast water from said water mass, said process comprising passing water from said water mass into said ballast tank through a siphon conduit having a headspace provided with a gas removal pump and at a pressure of no more than 0.5 atm.

Once siphonic flow has begun, the pumping power of the gas removal pump at the siphon headspace that is required to maintain siphonic flow is relatively low—it need only be powerful enough to remove the dissolved gas released from the ballast water as well as the water vapour produced at the water surface in the headspace. In other words, once the siphon has been initiated, practically no pumping power is required for the flow through the siphon conduit to continue. This therefore represents a process of ballast water treatment that can be more energy efficient than known methods that actively and continuously pump water into, or even out of, a ballast tank.

Viewed from a further aspect the invention provides a ship having a ballast tank and a conduit for transferring water into or out of said ballast tank, characterised in that said conduit has a siphon headspace provided with a gas removal pump.

It will be understood that what is meant by a siphon conduit is a flow passage that includes a region of sub-atmospheric pressure such that liquid entering the conduit at atmospheric pressure is pulled along the flow passage without requiring a pump. Similarly, a siphon headspace may be a volume of sub-atmospheric pressure. An example of a conventional siphon conduit is a tube in an inverted U shape which causes a liquid to flow up the inflow portion of the tube above the surface of a reservoir, without pumps, powered by the fall of the liquid as it flows down the outflow portion of the tube under the pull of gravity to be discharged at a level lower than the surface of the reservoir.

Creation of siphonic flow may be facilitated in several ways. Thus for example the inflow portion of the siphon conduit leading to the headspace may be provided with a water pump; the siphonic headspace may be physically lowered (for example using a winch or crane) to at least partially fill the inflow portion before being raised to create an under-pressure in the headspace; or the siphon conduit may be provided downstream of the headspace with a downflow portion followed by an upflow portion and gas (e.g. nitrogen or nitrogen-rich air) may be introduced at the base of the upflow portion. This latter arrangement is particularly preferred as the nitrogenated ballast water entering the ballast tank is less supportive to corrosion of the ballast tank and to any multicellular life forms that may survive ballast water loading.

Viewed from a further aspect the invention provides a ballast water transfer apparatus comprising: a water reservoir; and a siphon conduit having an inlet in said reservoir, a siphon headspace provided with a gas removal pump, and an outlet; said conduit preferably also comprising a downflow section and an upflow section downstream of said headspace, said upflow section preferably being provided towards its base with an inlet port for introduction of compressed gas.

As ballast water loading progresses, the deck level of the ship will drop and to maintain the degassing effect of the headspace in the siphon it may be necessary to increase the pumping rate of the gas removal pump, to raise the water level in the headspace, or to maintain a low surface level for the water surrounding the inflow portion. The latter two alternatives are preferable in that they do not require any significant increase in power consumption by the gas removal pump.

Thus in one embodiment, the inflow section and the downflow section of the siphon conduit may be connected by a plurality of valved, isolatable, vertically separated short-cut sections. As ballast water loading progresses, the shortcut sections are progressively closed from bottom upwards (e.g. with higher shortcut sections correspondingly being opened from bottom upwards).

In another, less preferred embodiment, as ballast water loading progresses, the inflow and headspace sections of the siphon conduit are physically raised, e.g. by a winch or drive motor. This is less preferred since the space occupied by the ballast water loading apparatus will change as the loading progresses.

In a third, particularly preferred embodiment, ballast water is filled, e.g. under gravity, into an intermediate reservoir located towards the base of the ship, from which it enters the inflow portion of the siphon conduit. In order to maintain a sufficiently stable water level in this intermediate reservoir, it may be filled from one or a series of vertically spaced ports on the side of the vessel, provided with valves to maintain the water level at an acceptable level. If desired such an intermediate reservoir may be exterior to the ship, for example provided by the docking facilities. As ballast water is transferred from such an external reservoir, the height difference between the water level in the reservoir and the headspace of a shipboard siphon unit may readily be maintained, e.g. by addition or removal of water or by the water level drop in the reservoir due to transfer into the ships ballast tanks.

If desired, the entire siphon unit may be external to the ship, e.g. provided by the docking facilities.

To increase degasification in the siphon headspace, this is preferably provided with a large gas-water interface, for example by having flow disrupters, for example plates or baffles extending into the upper portion of the downflow section of the siphon conduit or a large area non-smooth surface at the base of the headspace.

Besides degasification by the action of the vacuum at the headspace of the siphon, the ballast water being loaded onto the ship may be subjected to further treatment to reduce biological contamination or to reduce the ability of the ballast water to corrode the ballast tanks. Thus the inflowing water may be passed through a mesh or grid to prevent large objects from passing into the ballast tanks, the inflowing water may be passed through a macerator to kill fish or shellfish, the inflowing water may be subjected to an alternating electrical field to kill micro organisms, and/or the degassed water may be re-saturated with nitrogen or nitrogen-rich air.

Once the ballast water is loaded, the headspace in the ballast tank is preferably maintained in an oxygen-poor state, e.g. by flushing with nitrogen or nitrogen-rich air.

To further reduce microorganism contamination of ballast water during the voyage of the ballast water laden ship, the ballast water may be degassed, and preferably re-gassed with a gas free from or low in oxygen (e.g. nitrogen, oxygen depleted air, a noble gas or, less preferably, an exhaust gas), using a siphon conduit in a similar fashion. Thus, viewed from a further aspect the invention provides a method of treating ballast water on board a ship to combat microorganism infestation thereof, said method comprising cycling ballast water from a ballast tank in said ship to a ballast tank in said ship through a siphon conduit having a siphon headspace provided with a gas removal pump.

In this treatment method, the ballast water may be cycled from one ballast tank to another or, more preferably, from one ballast tank and back into the same ballast tank. The degassing and regassing will serve to kill many macro- and microorganisms, thus preventing build up within the ballast water of contaminating organisms during the voyage.

To reduce build up of anaerobic microorganisms during the voyage, the treatment method of the invention may be effected with regassing with air or oxygen. Degassing will remove dissolved carbon dioxide and this, and oxygenation, will result in the killing of obligate anaerobes and those which rely on carbon dioxide. However, if regassing with an oxygen-containing gas is effected, it is desirable first to flush the ballast tank headspace with nitrogen to remove any methane that may have built up. To avoid ballast tank corrosion, regassing with an oxygen-containing gas is preferably followed by further treatment with regassing with nitrogen and further flushing of the ballast tank headspace with nitrogen.

A further advantage of treatment according to the invention during transit lies in the removal of corrosive materials, such as hydrogen sulphide, that may build up during the voyage. Once again, it is desirable also to flush the ballast tank headspace with nitrogen to ensure that such materials, if they have accumulated in the ballast tank headspace, are also removed.

Where treatment involves use of a gas low in oxygen content, the oxygen content is desirably less than 15 mole %, especially less than 5 mole %, more especially less than 2 mole %.

The ballast water treatment in transit is preferably accompanied by treatment with an electric field, e.g. an alternating field, to ensure that as much as possible of the microorganism load in the ballast water is eliminated.

Ballast water treatment according to the invention may be effected continuously once the ballast water has been loaded, since the energy requirement of the gas removal pump in the siphon headspace is low. However alternatively it may be effected once or more than once during the voyage, e.g. at 3˜7 day intervals.

When the ballast water is to be discharged, this may be achieved readily by use of the siphon unit operating in reverse. In order that the discharged ballast water should not adversely affect the water mass into which discharge occurs, it is preferred that it be aerated or oxygenated on discharge. This may readily be achieved by using compressed air to provide uplift to the discharged water in an upflow section of the siphon conduit downstream of the siphon headspace, i.e. in an equivalent manner to the compressed nitrogen used to provide uplift to the ballast water during loading as described above. Alternatively air may simply be bubbled into the water during discharge.

Viewed from a further aspect therefore the invention provides a method of discharging ballast water from a ballast tank of a ship in a water mass, said method comprising passing water from said ballast tank into said water mass through a siphon conduit having a headspace provided with a gas removal pump.

A feature common to the various methods and apparatus described above for the treatment of ballast water is that of transferring water, with minimal energy demand, through a siphon conduit having a siphon headspace provided with a gas removal pump to degas the water. Such a process and setup has been found to be surprisingly effective in removing microorganisms from water and may find use in treating water, both seawater and fresh water, for applications other than ballast water. Viewed from a further aspect the invention provides a method of treating water to combat microorganism infestation thereof, said method comprising transferring water from a reservoir to a tank or outlet through a conduit having a siphon headspace provided with a gas removal pump.

In one set of embodiments wherein fresh (or desalinated) water is treated, there may be provided a method of drinking water sterilisation. Preferably the method comprises transferring fresh water from a source through a conduit to a drinking water tank or outlet, wherein the conduit contains a reduced pressure zone and the flow of water through the reduced pressure zone is siphonic. It has been found that large scale water sterilisation may be effected more efficiently, particularly in terms of materials and energy usage, if the water flow from the reservoir or other source is subjected to siphonic flow through a reduced pressure headspace. Preferably the reduced pressure zone provides a sub-atmospheric pressure, i.e. below approximately 1 bar. The reduced pressure in the reduced pressure zone may be applied and maintained by a pump, e.g. a vacuum pump. The reduced pressure in the reduced pressure zone is desirably less than 0.2 bar, particularly less than 0.1 bar, preferably less than 0.05 bar (50 mbar) and especially below 0.02 bar (20 mbar). Such pressures may be achieved by a standard vacuum pump requiring a power input of only a few kW. The energy demand of such methods of water treatment are much lower than conventional water sterilisation techniques, for example using ultraviolet irradiation.

While, in much of the world, biologically contaminated water is often treated with chlorine to kill the contaminating organisms, chlorine can provide the water with an unpleasant taste and any excess has to be removed, typically by passage through activated carbon filters, before the water is drunk. Thus water sterilisation by chlorination involves the use of large quantities of chlorine and of the carbon filters used to remove the chlorine. Other proposals for the sterilisation of drinking water include ultraviolet germicidal irradiation but, as mentioned above, such processes involve a large energy demand, which may not be achievable e.g. in developing countries.

In preferred embodiments the water source is typically a lake, reservoir or river and a suitable reservoir may be filled from one or more such sources. Where the method relates to drinking water sterilisation, i.e. treatment of fresh (or desalinated) water, the source is not the sea or of any other water too saline for consumption. By sterilisation is meant herein that the drinking water yielded by the method of the invention is sufficiently free of microorganisms capable of replicating as to be safe for human consumption. The drinking water outlet in the method of sterilisation will typically be a closable tap or such other outlet as drinking water is commonly taken from. Between the conduit and the outlet there may of course be an intermediate reservoir, e.g. a sterilised water storage tank.

While a siphonic flow is preferred to minimise the energy input required for the water treatment e.g. sterilisation process, it has been found that a process of passing water through a reduced pressure headspace can provide unexpected effects even when the flow is not siphonic. In particular, it has been found that a microbicidal effect is achieved when water is exposed to a pressure reduction of (at least) two orders of magnitude that results in a sub-atmospheric pressure. For example, water flowing through the conduit may undergo a pressure reduction from around 10 bar to around 100 mbar, from around 9 bar to around 90 mbar, from around 8 bar to around 80 mbar, from around 7 bar to around 70 mbar, from around 6 bar to around 60 mbar, from around 5 bar to around 50 mbar, from around 4 bar to around 40 mbar, from around 3 bar to around 300 mbar.

When viewed from a further aspect the invention provides a method of treating water, preferably of sterilising water for drinking, which comprises flowing water through a conduit containing a reduced pressure zone arranged to reduce the pressure of the flow by at least two orders of magnitude to a sub-atmospheric pressure.

In preferred embodiments water flowing through the conduit may undergo a pressure reduction from around 2.5 bar to around 25 mbar, from around 2 bar to around 20 mbar, or from around 1.5 bar to around 15 mbar. However, it is preferable for the initial water pressure to be around atmospheric so that pressurisation upstream of the reduced pressure zone is not necessary. Thus a pressure reduction from around 1 bar to around 10 mbar (or less) is preferred.

When viewed from a further aspect the invention provides a method of treating water, preferably of sterilising water for drinking, which comprises flowing water through a conduit containing a reduced pressure zone arranged to reduce the pressure of the flow from atmospheric (approximately 1 bar) to around 10 mbar or less.

As well as killing aquatic lifeforms such as artemia (brine shrimp), exposure to a 10² pressure reduction from atmospheric (or a pressure slightly higher than atmosphere) has been found to kill bacteria such as E. coli. This is a surprising result as previously it has been reported that applying a negative pressure during ballast water transfer will kill larger living organisms such as crawfish but not bacteria or viruses. Whereas, test results for a method according to the invention, for example applying a pressure drop from 2.3 bar down to approx. 17 mbar, have shown a 93% inactivation of bacteria in seawater. It is suggested that the magnitude of the pressure reduction (˜10²) and the sub-atmospheric final pressure (˜20 mbar or less) combine to cause gas expansion inside the cells of organisms, even in a unicellular bacterium, that disrupt its life processes.

The reduced pressure in the reduced pressure zone may be applied and maintained by a pump, e.g. a gas extraction pump or vacuum pump. The reduced pressure in the reduced pressure zone is desirably less than 10 mbar, particularly less than 5 mbar, especially below 1 mbar. Evaporation of water sets a natural lower limit to the reduced pressure.

The conduit at or within the reduced pressure zone is preferably such as to allow the reduced pressure to substantially deoxygenate the water flowing therethrough and desirably contains active, or more preferably passive, flow disrupters to ensure the water flow is turbulent. Furthermore, to increase degasification in the reduced pressure zone, this is preferably provided with a large gas-water interface, for example by having plates or baffles in the conduit or a large area with a non-smooth surface (as mentioned above in the context of ballast water). Water in the reduced pressure zone may be spread into a thin film or spray by a baffle arrangement or nozzle(s) so as to facilitate degassing. Particularly preferably, the conduit in the reduced pressure zone is horizontally elongate in cross-section, to maximise the surface area of the water flowing through that is exposed to the pressure reduction.

Water may be caused to flow through the conduit by various known means, for example flow through the conduit may be under the operation of gravity or a pump. In some embodiments water is pumped through the conduit, e.g. by a pump or impeller placed at a convenient location in the conduit. However, in order to minimise the energy requirements, gravitational flow is preferred. Not only can gravitational flow lower the energy requirements during operation but also, as will be described below, it may even reduce the operational energy requirement to zero.

A gravitational flow can be achieved, for example, by positioning an upstream inlet to the conduit higher than a downstream portion of the conduit. Thus, in preferred embodiments the conduit may comprise a downflow section followed by an upflow section. The reduced pressure zone may be located in or after the upflow section. Preferably, the gravitational water pressure in the conduit upstream of the reduced pressure zone is sufficient in itself to cause water to flow through the reduced pressure zone, e.g. before a gas extraction pump is set into operation. In such embodiments, it is advantageous for a turbine to be located within a downflow section of the conduit upstream of the reduced pressure zone which, when in operation, generates energy that may be used to power the gas extraction pump. The turbine is preferably such as to meet all the energy demands of the treatment system during operation, thereby making methods according to the invention extremely energy efficient.

Whether the flow through the conduit to the reduced pressure zone is driven by mechanical force (e.g. a pump) or by gravitational force, in preferred embodiments the energy demand is reduced by employing siphonic flow as in the ballast water treatment methods described above. It is therefore preferable that the water flow through the reduced pressure zone is siphonic. When the water flow through the reduced pressure zone in the conduit is siphonic, that is to say the water pressure immediately upstream of the zone is not in itself capable of causing water to continue to flow through the zone in the absence of the reduced pressure applied in the zone. Since a gas extraction pump is required to maintain the siphonic flow and since the energy required to maintain siphonic flow may be far less than that required to initiate siphonic flow, it will generally be preferred to use a starter pump in the conduit, upstream of the reduced pressure zone (or siphon headspace), to initiate siphonic flow. Where a pump is already provided to drive flow through the conduit (e.g. rather than gravitational flow) then this can also act as the starter pump. Once siphonic flow is initiated, the energy demand on the pump is reduced and hence a lower pump power can take over to maintain siphonic flow. Providing siphonic flow in combination with a reduced pressure zone therefore reduces the energy required as compared to methods of treating water in which the flow is actively pumped through a conduit.

In preferred embodiments of the invention, a vacuum (i.e. suction) is applied to a headspace in the conduit to provide the reduced pressure zone. The gas pressure in this headspace may be from almost vacuum to around 10 mbar. Where suction is applied at a high point of the conduit, as is preferred, this may generate a siphon effect to maintain continuous flow through the conduit. The effect of applying such a vacuum will also be to lift the water level in a downflow section relative to that in an upflow section. If 100% vacuum is applied, then absent any compensating system (e.g. gas injection as mentioned below) there would naturally be a water level difference of about 10 metres (1 atm=ρgh provides a height h of 10 m of water).

In the methods described for transferring water from a source or reservoir to a tank or outlet through a conduit having a reduced pressure zone, e.g. a siphon headspace provided with a gas removal pump, the treatment may be carried out in single or multiple batches. For example, depending on the degree of sterilisation required, the method may be repeated so as to pass water through the conduit several times before it is made available for human consumption. A continuous flow loop may even be provided.

While the method of the invention may be used with any desired flow rate, it is particularly suited for use at flow rates of above 1 m³/hour, especially above 1 m³/min, and particularly above 1 m³/sec.

In at least some embodiments, alternatively or in addition, water may be propelled through the conduit by injecting gas into the conduit at the base of an upflow section of the conduit (thereby reducing the overall density of the fluid in the upflow section relative to the density in a downflow section). Where gas injection at the base of an upflow section is used, a gas vent at or near the top of the upflow section may also be provided. Where gas injection occurs only in one upflow section, such venting can generally be to the atmosphere.

Where gas injection is used to drive the flow of water through the conduit, the gas is preferably pressured gas, particularly compressed air from a compressor, e.g. typically operating at a pressure of about 10 bar.

In some embodiments water flowing through the conduit can be supersaturated with a gas (e.g. nitrogen, oxygen or air) upstream of the reduced pressure zone to maximise the degassing effect. Preferably a separator is provided downstream of the supersaturation zone to remove gas bubbles from the water before it reaches the reduced pressure zone. Otherwise any gas bubbles present would be removed by the vacuum pump and make it harder to achieve the desired pressure reduction.

In some preferred embodiments of the above methods of treating water, especially to provide drinking water, an additional microbicidal effect can be achieved by introducing nitrogen gas into the water as it flows through the conduit, preferably introducing nitrogen into the water upstream of the reduced pressure zone or siphonic headspace. The addition of nitrogen helps to “strip” oxygen (together with nitrogen) out of the water during the reduced pressure degassing. Especially when treating water for drinking, by adding a gas such as nitrogen to supersaturate the water prior to degassing the bactericidal effect can be increased. It is believed that gas diffuses into the cell of each bacterium as a result of supersaturation and when the pressure is reduced (especially by 10² or more) the cell walls can not contain the gas and it causes the organism to rupture. The degassed water may advantageously find direct use as ballast, without a post-gassing step of nitrogen saturation as mentioned above. The headspace in the ballast tank may still be filled with nitrogen to help prevent organism re-growth. For drinking water a reoxygenation step may be added downstream.

Several further preferred embodiments will now be described that may be used, alone or in any combination, with one or more of the embodiments outlined above to contribute to or improve the degassing and/or sterilisation effects of the invention.

While the effect of the reduced pressure zone on fresh water will be sufficient to kill or deactivate a large proportion of the microorganisms it contains, it is desirable that at least one other microbicidal technique be used, either upstream or downstream of the reduced pressure zone (or siphon headspace). Typical such techniques include UV irradiation, electric shock, nitrogen saturation, chlorination, ozone treatment, pressure shock, maceration, filtration and/or ultrasonic treatment. Chlorination, if used, may involve a lower level of chlorine exposure than would normally be required in the absence of a pressure reduction and indeed chlorination is not a preferred additional microbicidal technique as it imposes a demand for raw materials, besides fresh water, during operation. Nitrogen saturation, which would typically be effected upstream of the reduced pressure zone, is likewise not preferred as it again imposes extra materials demand.

Particularly preferably the method of the invention uses pressure shock, ultrasound and/or UV exposure as the further microbicidal technique(s).

Where pressure shock is used, this is preferably done upstream of the reduced pressure zone. The pressure shock method involves passing the flowing water from a smaller to a larger cross-sectional area part of the conduit, e.g. by placing a constriction within the conduit. This is energy efficient however only when flow from the source is gravitational.

Ultrasonic irradiation may be a preferred further microbicidal technique. For example, high power ultrasound can be applied to produce cavitation that facilitates cellular disintegration and kills bacteria. Ultrasound may be particularly useful for stripping oils from algae in the water to be treated.

Embodiments of the present invention may find particular use in combination with the ozone treatment of water. Ozone is often used as an alternative to chlorine to kill micro-organisms in drinking water. Although ozone does not remain in the treated water but decays back to oxygen, it can be desirable to remove ozone immediately after treatment due to its high reactivity and potential for causing damage to conduit pipes, seals and other components in a treatment system. Typically carbon filters may be used to remove the ozone. In one set of embodiments there is provided a method in which water is treated with ozone in the conduit before entering the reduced pressure zone (or siphon headspace). Advantageously any ozone remaining in the water is removed by degasification rather than requiring a carbon filter for this purpose.

Another preferred further anti-microbial treatment for use in methods of the invention is UV irradiation and the conduit is preferably equipped for UV irradiation of the water flow should that be desired, for example if the water source is found to be contaminated by an organism resistant to the de-oxygenation and reduced pressure exposure which is provided by the invention.

Such UV treatment is readily effected with UV lamps mounted in or outside the conduit. For efficiency, such lamps may be disposed within the water flow in bundles of parallel lamps extending along the flow direction. More preferably however they will be disposed above the flowing water in sections of the conduit where the water is shallow, e.g. in sections where in cross section the conduit is broader than it is tall. The lamps will preferably be arranged to irradiate the flowing water over a distance of at least 1 m, preferably at least 5 m, especially at least 10 m in the flow direction. To ensure the maximum efficiency of irradiation, at least part of the inner wall of the conduit in the irradiation zone is UV light-reflecting, e.g. polished. If desired the UV lamps may be mounted outside the conduit where the relevant section of the conduit has a UV light transparent wall or where the conduit is open. Particularly preferably the UV lamps are mounted in the headspace of the reduced pressure zone and optionally also in a downflow section of the conduit immediately following the reduced pressure zone.

As mentioned above, where, as is preferred, water flow from the source is gravitational, it is preferred to mount a turbine within the conduit to generate electricity to operate the vacuum pump and any UV lamps of the treatment system. One example of a suitable turbine is the helical turbine developed by Gorlov (see U.S. Pat. No. 5,451,138, U.S. Pat. No. 6,036,443, etc.).

While the electrical output from the turbine need to be no more than that required to run the vacuum pump and UV lights, where the turbine is upstream of the reduced pressure zone the operation of the turbine will reduce the pressure of the water between the turbine and the reduced pressure zone. In a preferred embodiment, the system is arranged such that with the turbine non-operational the water pressure is sufficient to establish water flow through the reduced pressure zone. With the turbine then becoming operational, the electric output will be sufficient to maintain siphonic flow and effect UV irradiation. In this way the requirement for external power sources is minimized.

The part of the conduit immediately downstream of the vacuum pump desirably has a downflow section which in operation will not be completely full of water. This section may be vertical or inclined and preferably contains baffles or other means to cause turbulence in the water flowing through. This section too may be equipped with UV lamps. This section may also be equipped with a turbine, especially a helical turbine. Such a turbine may contribute to meeting the energy demands of the system by harnessing some of the kinetic energy of the water—this is particularly important when the water flow from the source is pumped rather than gravitational. The vertical water drop from the vacuum headspace to the point where the conduit is filled with water is preferably at least 5 m, more preferably at least 9 m.

In practice, it is preferred to use two or more conduits in parallel each containing a reduced pressure zone so that water treatment may continue during the period one conduit is non-operational for repair or maintenance.

The water used in methods of the invention is preferably filtered, for example through a ceramic, clay or activated carbon filter bed, to enhance purity. Such filtering may take place either upstream or downstream of the reduced pressure zone or siphonic headspace.

It has further been appreciated that when treating water, either for ballast water or drinking water, it can be desirable to physically remove the dead microorganisms or their by-products produced by the degassing process. For example, it is known that the rupture of algae can release toxins. Thus in one set of embodiments there is provided means to remove particles and/or organisms from the water before it is passed through the reduced pressure zone. This may be achieved by physically filtering the water in a portion of the conduit upstream of the reduced pressure zone. In other embodiments the filtering may take place in the headspace, for example during an initial pass without the full pressure reduction and then followed by a later pass with the pressured reduction applied. One or more of a mesh filter, centrifugal or cyclonic separator and/or ultrasound irradiation may be used to separate out undesired entities. As mentioned above, water flowing through the conduit may be exposed to ultrasound in order to disrupt algae and extract oils therefrom.

While embodiments of the present invention have been described in the context of treating ballast water or drinking water, there may be other applications of the methods and apparatus described herein. For example, water used in aquaculture could benefit from the removal of bacteria and/or unwanted gases (such as CO₂). The water to be treated may be fresh water and/or sea water. In pre-smolt salmon farming the hatcheries are typically exposed to a flow of recycled fresh water that may also contain a small amount of salt water before the smolt (juvenile salmon) are transferred to sea pens. Such water may beneficially be treated in a conduit containing a reduced pressure zone as it is recycled.

Some embodiments of the invention will now be described, by way of example only, and further with reference to the accompanying drawings, in which:

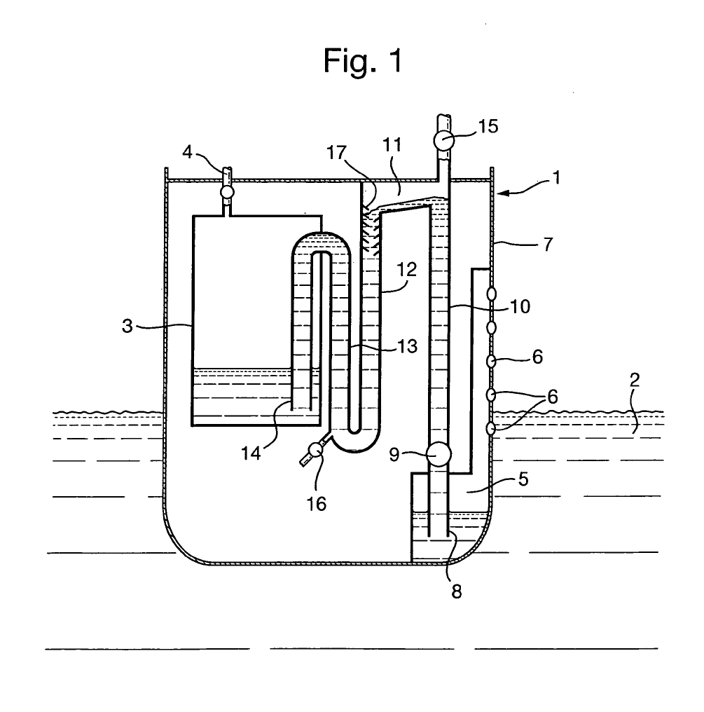

FIG. 1 is a schematic cross-sectional drawing of a ship provided with a first ballast water loading apparatus according to the invention;

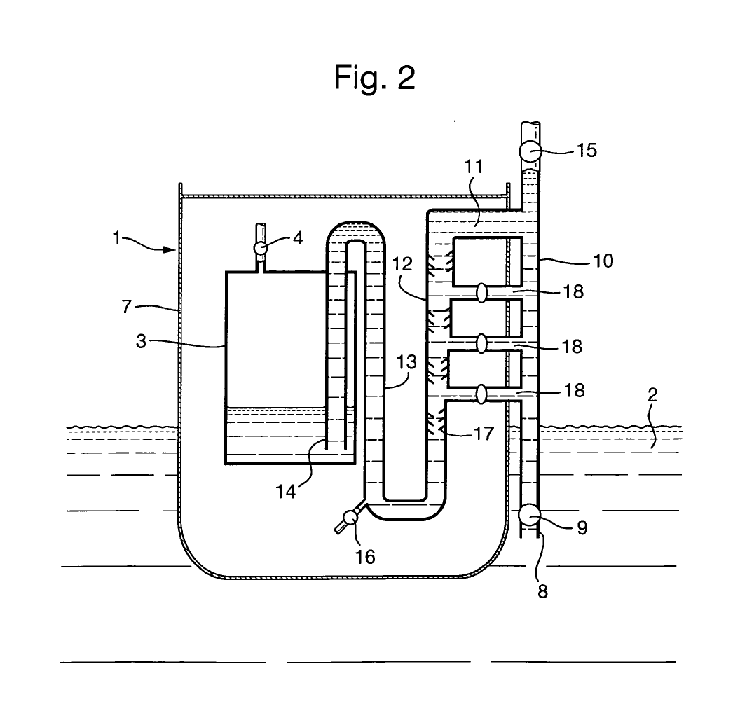

FIG. 2 is a schematic cross-sectional drawing of a ship provided with a second ballast water loading apparatus according to the invention;

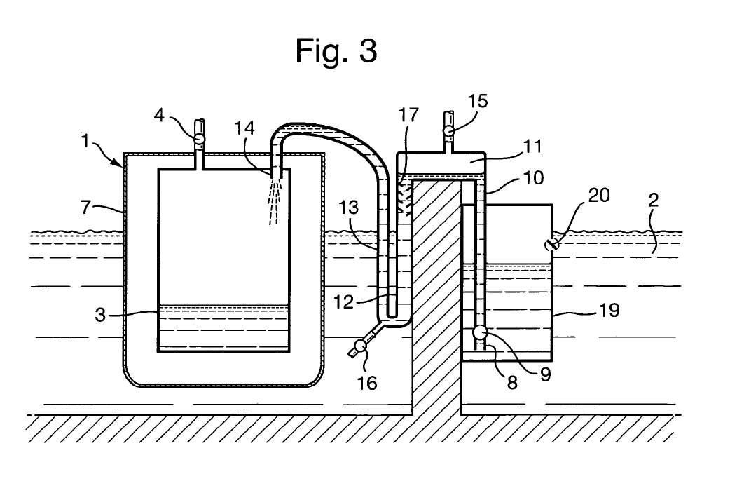

FIG. 3 is a schematic cross-sectional drawing of an on-shore ballast water loading apparatus according to the invention;

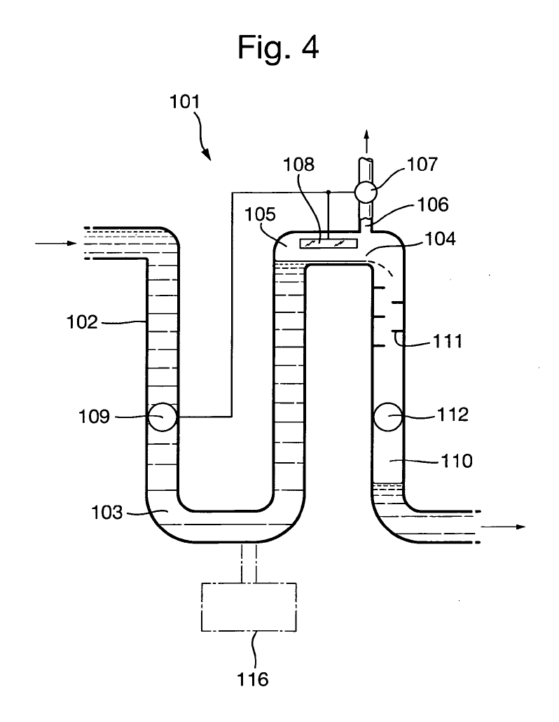

FIG. 4 is a schematic diagram of one embodiment of apparatus to treat water, using gravitational flow;

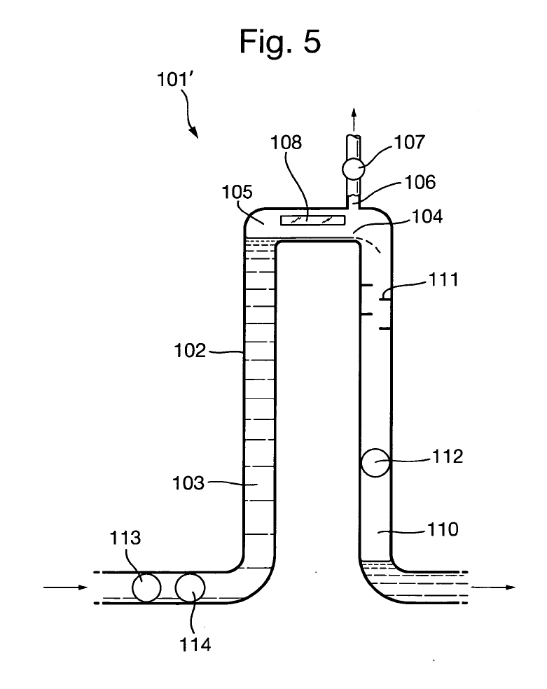

FIG. 5 is a schematic diagram of another embodiment of apparatus to treat water, using pumped flow;

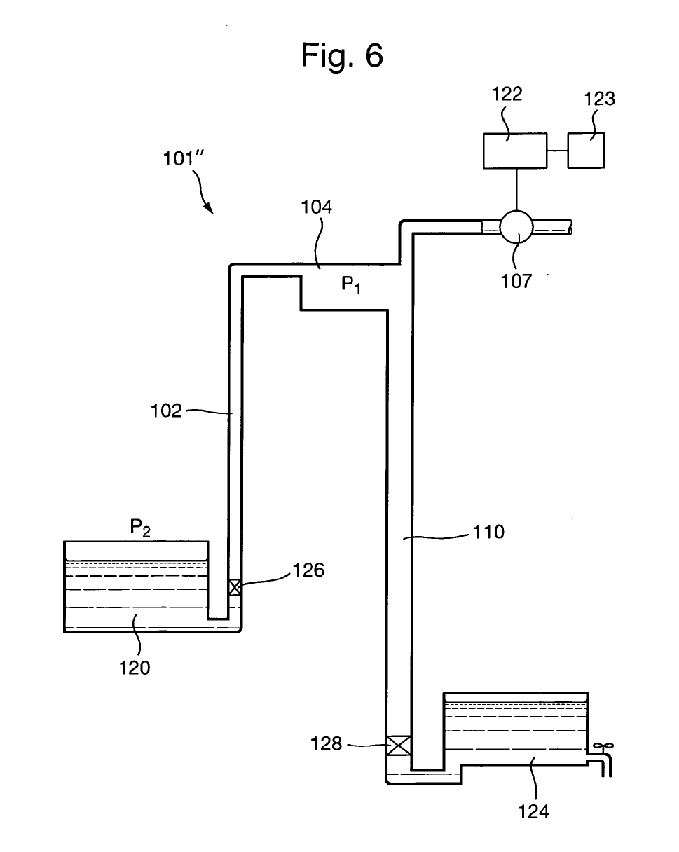

FIG. 6 is a schematic diagram of another embodiment of apparatus to treat water, using siphonic flow;

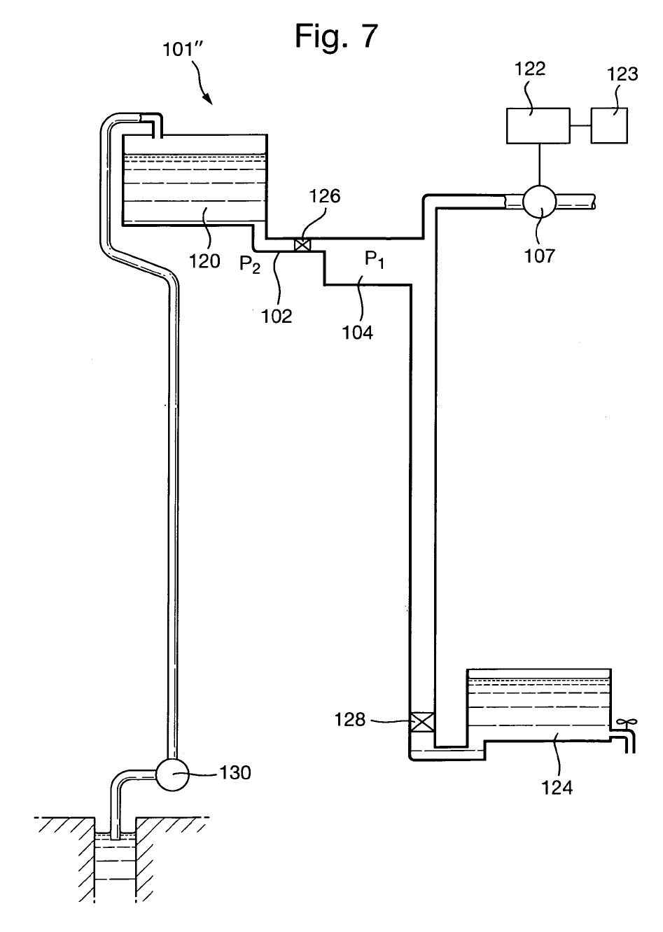

FIG. 7 is a schematic diagram of a further embodiment of apparatus to treat water in a first version;

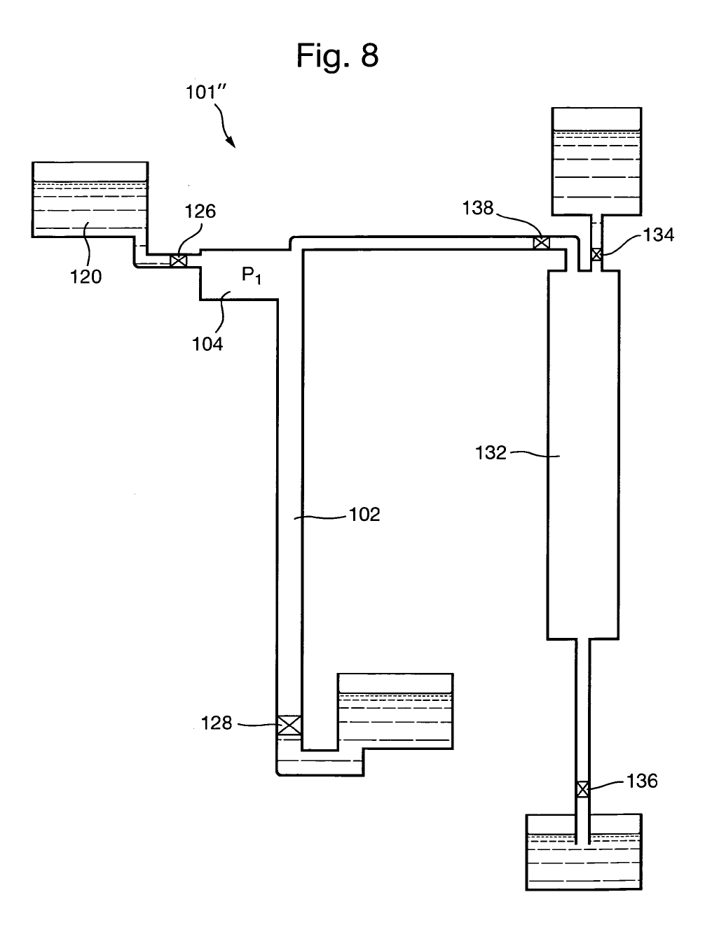

FIG. 8 is a schematic diagram of a further embodiment of apparatus to treat water in a second version; and

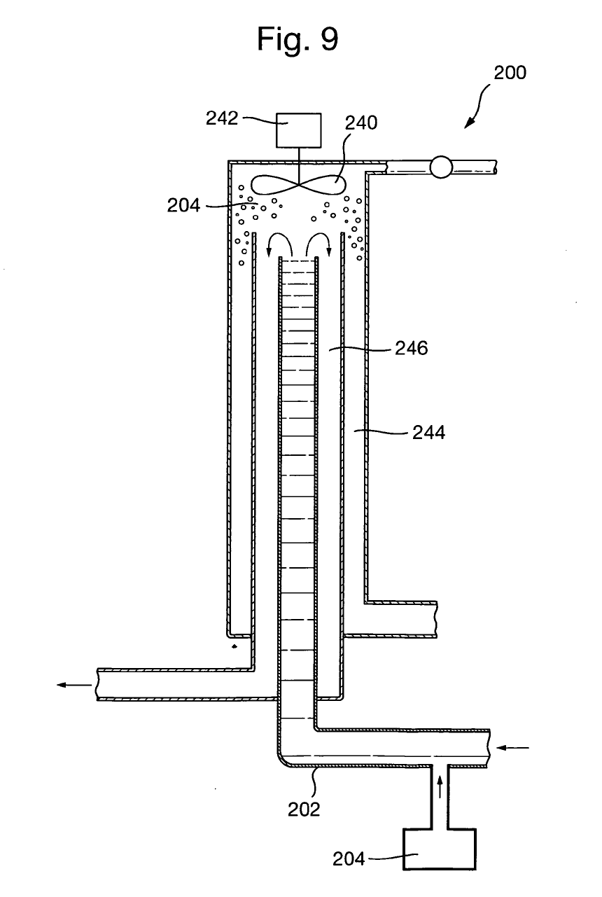

FIG. 9 is a schematic diagram of a skimming system for use in any of the apparatus of FIGS. 1 to 8.

Referring to FIG. 1 there is shown a ship 1 afloat in water mass 2 (e.g. the sea) and containing a ballast tank 3 having a gas vent 4 to prevent build up of overpressure. The ship is also provided at its base with an intermediate reservoir 5 which may be filled to a desired level with water from the water mass through valved vent(s) 6 in the ship's outer hull 7.

A siphon conduit 8 immersed in the water in reservoir 5 and provided with a starter pump 9 runs via inflow portion 10 to headspace 11 to downflow portion 12 and upflow portion 13 to discharge into ballast tank 3 through outlet 14. Headspace 11 is provided with a gas removal pump 15 capable of maintaining a pressure of no more than 0.5 atmos, preferably no more than 0.1 atmos, especially no more than 0.05 atmos in the headspace during water transfer. Upflow portion 13 is provided near its base with an inlet 16 for admission of compressed nitrogen from a compressed nitrogen source (not shown).

During ballast water loading, the water level in reservoir 5 is maintained sufficiently high to cover the inlet of the siphon conduit by opening and closing vent(s) 6. Starter pump 9 and gas removal pump 15 are set in operation to raise the water in inflow portion 10 to cause the water to siphon over into downflow portion 12 whereafter compressed nitrogen is introduced into upflow portion 13 to give an uplift to the water therein and cause it to flow into the ballast tank 3. Once siphonic flow has been set in train, the starter pump may be switched off.

The upper part of the interior of downflow portion 12 is provided with plates or baffles 17 to disrupt water flow in its upper, gas-containing section. The vertical distance from the base of headspace 11 to the water level in reservoir 5 is preferably at least 5 metres especially at least 8 metres. The upper limit is of course set by the density of the water and the atmospheric pressure at about 10 metres.

In the alternative embodiment shown in FIG. 2, the inflow portion 10 has its inlet in the water mass and is connected to the downflow portion 12 by a plurality of valved short-cut portions 18. When ballast loading commences, only the lowest of the short-cut portions is open, but as the water loading progresses and the ship sinks lower in the water, the lowest is shut and the next lowest opened and so on until loading is complete.

In the second alternative embodiment shown in FIG. 3, the reservoir 19, the headspace 11, downflow portion 12 and upflow portion 13 are mounted onshore. As the loading of ballast water progresses, the relative height difference between the water level in the reservoir 19 and the deck of the ship is maintained by adding water to the reservoir 19 from the water mass through a valved vent 20 in the reservoir wall.

Referring to FIG. 4, there is shown a drinking water treatment apparatus 101 comprising a conduit 102 containing water 103 fed under gravitational flow from a reservoir (not shown). Conduit 102 includes a reduced pressure zone 104 having a headspace 105 provided with a gas outlet 106 attached to a vacuum pump 107. Within the headspace 105 there is disposed a UV lamp array 108 to irradiate water flowing through the reduced pressure zone 104. Within conduit 102, upstream of the reduced pressure zone 104, is disposed an electricity-generating turbine 109 arranged to supply power to the vacuum pump 107 and UV lamp array 108. Downstream of the headspace 105, the conduit 102 has a downflow section 110 containing baffles 111 to disrupt water flow and a further turbine 112 to capture some of the kinetic energy of the water. The water level in downflow section 110 is preferably at least 5 m below the water level below the headspace, particularly at least 9 m. Further baffles (not shown) may be employed in the headspace 105 to help spread the water into a thin film to maximise exposure to the vacuum.

In operation, before turbine 109, pump 107 and lamps 108 are activated, a water flow through reduced pressure zone 104 is allowed to develop. The flow is driven by gravity upstream of the headspace 105. The upstream turbine 109 is then activated and the power generated together with the downstream turbine 111 is used to run the vacuum pump 107, e.g. generating a pressure of around 10 mbar in the reduced pressure zone 104. Once the pressure reduction in the zone 104 is sufficient to maintain siphonic flow, the UV lamps 108 may be activated using power from the turbines 109 and 111.

Referring to FIG. 5, there is shown an apparatus 101′ for drinking water treatment comprising a conduit 102 containing water fed from a source (not shown) using a starter pump 113. The conduit 102 is provided with a reduced pressure zone 104, headspace 105, gas outlet 106, vacuum pump 107, UV lamps 108, downflow section 110, baffles 111, and turbine 112, as in the embodiment shown in FIG. 4. The starter pump 113 is used to initiate siphonic flow whereafter turbine 112 is used to supply at least part of the energy required by the vacuum pump 107 and lamps 108. Once siphonic flow is initiated, the energy demand on the starter pump 113 is reduced and a lower power (and hence lower energy usage) pump 114 may take over. Alternatively, a single pump with variable power may be used instead of the two pumps 113 and 114.

Referring to FIG. 6, in this apparatus 101″ untreated water is drawn through a conduit 102 from a reservoir 120 to a reduced pressure zone 104 located at least 10 m above the reservoir 120. A vacuum pump 107 is connected to the headspace 104 and powered by a solar panel 122 with a battery 123. A low power e.g. 0.25 kW pump may be used. The conduit 102 includes a downflow pipe 110, downstream of the headspace 104, leading to a treated water tank 124. In operation, the vacuum pump 107 is turned on with an inlet valve 126 preventing water from being drawn out of the reservoir 120 and an outlet valve 128 locking out the tank 124. When a suitably low pressure P₁ is measured at the headspace 104, the inlet valve 126 is opened and water is sucked up through the conduit 102 to the reduced pressure zone 104. After depressurisation, the treated water flows along the downflow portion 110 of the conduit 102 and fills the bottom of the downflow pipe. Once the water level has equalised with the reservoir 120, the outlet valve 128 can be opened to release treated water into the tank 124. The valve 128 can be closed and re-opened as necessary to ensure that a suitable pressure difference is maintained between the reservoir 120 (at pressure P₂) and the headspace 104 (at pressure P₁), for example P₂/P₁≧100.

FIG. 7 relates to a variation of the apparatus 101″ seen in FIG. 6. In this embodiment untreated water enters the apparatus from a reservoir 120 that is gravitationally raised relative to the treated water tank 124. Water may be transferred into the reservoir 120 by a hand pump 130, for example. There is a gravitational flow through the conduit 102 into a reduced pressure zone 104. As before, the reduced pressure zone 104 is connected to a vacuum pump 107 run from a solar panel 122 (and optional battery 123). Operation of the apparatus 101″ is substantially the same as described above, except that lower pump power will be required to initiate the treatment process.

FIG. 8 shows another variation of the apparatus 101″ seen in FIGS. 6 and 7. In this embodiment the vacuum pump 107 has been replaced with a vacuum creating flow pipe 132. By pouring e.g. dirty water through the flow pipe 132 a vacuum may be created in the reduced pressure zone 104 without requiring electricity. The inlet valve 134 of the vacuum creator is opened to fill the flow pipe 132 with water. The outlet valve 136 is then opened to allow water to flow out of the pipe 132 and create a vacuum. A further valve 138 connects the flow pipe 132 to the vacuum headspace 104. The flow pipe 132 can be filled and emptied multiple times until a suitable pressure P₁ is measured in the headspace 104. Once a reduced pressure zone has been created, the valve 138 is closed to isolate the headspace 104 and then the inlet valve 126 can be opened to allow water to flow from the reservoir 120 into the headspace 104. The outlet valve 128 can be opened and closed as necessary to remove treated water from the conduit 102 and keep the pressure P₁ at a low level, reduced by around 10² compared to the reservoir 120.

Although not shown, turbines as described above may be incorporated into any of the apparatus seen in FIGS. 6 to 8. Furthermore, in any of the apparatus shown in FIGS. 4 to 8 there may be provided a source 116 (seen in outline in FIG. 4) of gas, such as nitrogen, communicating with the conduit 102 upstream of the headspace 104. By supersaturating the water to be treated with gas, the degassing effect of the vacuum pump 107 can be improved. A bubble separator may be provided between such a gas source 116 and the headspace 104 to remove any gas bubbles that could interfere with the degassing.

Finally, there is seen in FIG. 9 a skimming system 200 based on a tube-in-tube principle. Gas from a source 204 is added to the water as it enters the flow conduit 202, to make gas bubbles. Organisms to be removed such as bacteria, algae, viruses, etc. stick to the gas bubbles as they rise into the vacuum headspace 204. A rotating fan blade or propeller 240 run by a motor 242 is arranged in the headspace 204. As there is practically no air resistance, the fan 240 effectively impacts the physical matter collected by the gas bubbles and slings this residue into an outer pipe 244 where it is collected separately. The treated water runs down a coaxial pipe 246 of the flow conduit 202. The skimming process might be carried out at a reduced pressure of around 100 mbar rather than the full vacuum of 10 mbar or less. The separation process might be provided by an initial skimming run of the apparatus 200, or it might be provided by an upstream loop that is connected to a downstream apparatus loop applying a reduced pressure zone as previously described. Removing matter such as algae before degassing water using a large pressure reduction can help to prevent rupture that could otherwise release oils and/or toxins that are difficult to remove from the water.

### EXAMPLES

In Example 1, a series of tests was carried out on seawater with coliform bacteria, in particular E. coli bacteria, added. The water was pumped at a pressure of 2300 mbar bar through a conduit at different temperatures. In some of the tests a vacuum pump was used to apply a reduced pressure zone in the conduit. The results are given in Table 1.

TABLE 1

| | | | | Result A: | Result B: |
|---|---|---|---|---|---|
| | | | | E. coli | E. coli |
| | | Initial | Reduced | bacteria | bacteria |
| | | pressure | pressure | (ppm per | (ppm per |
| Test | Temperature | (mbar) | (mbar) | 100 ml) | 100 ml) |
| Ref. 1 | 24° C. | 2300 | None | 318 | 494 |
| Ref. 2 | 22.5° C. | 2300 | None | 169 | 166 |
| Ref. 3 | Ambient | 2300 | None | 106 | 120 |
| 1 | 7° C. | 2300 | 15-24 | 7 | 1 |
| 2 | 11.3° C. | 2300 | 15-24 | 0 | 1 |
| 3 | 14.5° C. | 2300 | 15-24 | 5 | 20 |
| 4 | 18° C. | 2300 | 15-24 | 0 | 0 |
| 5 | 19.6° C. | 2300 | 15-24 | 0 | 0 |

The results in Table 1 show that a reduced pressure zone is highly effective at killing E. coli bacteria across a range of temperatures.

In Example 2, similar tests were carried out at 24° C. on seawater contaminated with coliform bacteria, in particular E. coli bacteria, but with the addition of gas. The results in Table 2 demonstrate a further improvement in the sterilisation achieved. The same microbicidal effect was achieved with a lesser pressure reduction.

TABLE 2

| | | | | Result A: | Result B: |
|---|---|---|---|---|---|
| | | | | E. coli | E. coli |
| | | Initial | Reduced | bacteria | bacteria |
| | | pressure | pressure | (ppm per | (ppm per |
| Test | Gas addition | (mbar) | (mbar) | 100 ml) | 100 ml) |
| 6 | No N₂ | 2300 | 25-34 | 1 | 0 |
| | 1.3 ppm O₂ | | | | |
| 7 | Medium N₂ | 2300 | 25-34 | 0 | 0 |
| | 0.27 ppm O₂ | | | | |

I claim:

1. A method of treating water, which comprises flowing water through a conduit containing a reduced pressure zone arranged to reduce the pressure of the flow by at least 10² to a sub-atmospheric pressure.

2. (canceled)

3. A method as claimed in claim 1 that is a method of drinking water sterilisation.

4. A method as claimed in claim 1, wherein said method comprises transferring fresh water from a source through said conduit to a drinking water storage tank or outlet.

5. A method as claimed in claim 1, wherein the flow of water through said reduced pressure zone is siphonic.

6. A method of drinking water sterilisation which method comprises flowing fresh water from a source through conduit and to a drinking water reservoir or outlet, wherein said conduit contains a reduced pressure zone, and wherein water flow through said reduced pressure zone is siphonic.

7. A method as claimed in claim 1, wherein a vacuum pump or gas removal pump is used to form the reduced pressure zone in the conduit.

8. (canceled)

9. A method as claimed in claim 1, wherein the flow of water to said reduced pressure zone is gravitational.

10. A method as claimed in claim 9, wherein the conduit comprises a downflow section to create the gravitational flow followed by an upflow section with the reduced pressure zone located in or after the upflow section.

11. A method as claimed in claim 9, wherein an electricity-generating turbine is disposed in said conduit upstream of said reduced pressure zone.

12. A method as claimed in claim 1, wherein water flowing through said conduit is supersaturated with a gas upstream of the reduced pressure zone.

13. A method as claimed in claim 1, wherein nitrogen is introduced into the water upstream of the reduced pressure zone.

14. A method as claimed in claim 1, wherein the water flowing through said conduit is subjected to one or more additional microbicidal techniques selected from: UV irradiation; pressure shock; electric shock; filtration; maceration; boiling; chlorination; ozone treatment; and/or ultrasonic irradiation.

15. A method as claimed in claim 1, further comprising the step of physically separating particles and/or organisms from the water flowing through the conduit.

16. A drinking water sterilisation apparatus comprising a water reservoir and a conduit for transferring water from the reservoir to a reduced pressure zone, wherein the reduced pressure zone is connected to a pressure reducing means operable to reduce the pressure of the water from P₂ at the reservoir to a sub-atmospheric pressure P₁ at the reduced pressure zone, wherein P₂/P₁≧10².

17. A method as claimed in claim 1 that is a method of treating ballast water.

18-27. (canceled)

28. A method as claimed in claim 6, wherein a vacuum pump or gas removal pump is used to form the reduced pressure zone in the conduit.

29. A method as claimed in claim 6, wherein the reduced pressure zone is arranged to reduce the pressure of the flow from atmospheric (approximately 1 bar) to around 10 mbar or less.

30. An apparatus as claimed in claim 16, wherein the flow of water through the reduced pressure zone is siphonic.

31. An apparatus as claimed in claim 16, wherein the pressure reducing means comprises a vacuum pump or a gas removal pump.
